(19) United States
(12) Patent Application Publication
(10) Pub. No.: US 2025/0136286 A1
(43) Pub. Date: May 1, 2025

(54) SAFETY CONTAINER TO HOLD A BURNING BATTERY POWERED OBJECT, AIRCRAFT GALLEY AND AIRCRAFT

(71) Applicant: Airbus Operations GmbH, HAMBURG (DE)

(72) Inventor: Gregor PRAWINSKI, HAMBURG (DE)

(21) Appl. No.: 18/926,469

(22) Filed: Oct. 25, 2024

(30) Foreign Application Priority Data
Oct. 26, 2023 (EP) 23206111.9

(51) Int. Cl. B64D 25/00

(52) U.S. Cl. CPC B64D 25/00

(57) ABSTRACT

A safety container for holding at least one burning battery-operated object, wherein the safety container can be closed in an airtight manner and is fire-resistant. In the safety container, smoke is let out in a controlled manner and fed into existing discharge lines. The smoke and gases are cooled down before being vented. Also an aircraft galley having such a safety container and an aircraft having such an aircraft galley.

### CROSS-REFERENCES TO RELATED APPLICATIONS

This application claims the benefit of European Patent Application Number 23206111.9 filed on Oct. 26, 2023, the entire disclosure of which is incorporated herein by way of reference.

### FIELD OF THE INVENTION

The present invention relates to a safety container for holding at least one burning battery-operated object, wherein the safety container can be closed in an airtight manner and is fire-resistant. In addition, the present application relates to an aircraft galley having such a safety container and an aircraft having such an aircraft galley.

### BACKGROUND OF THE INVENTION

The present case relates specifically to safe handling of battery-operated devices, e.g. battery-operated wheelchairs, but, above all, personal electronic devices (PEDs), such as mobile telephones, laptops, tablets, smart watches, etc., in which thermal runaway is possible, for example if the battery is damaged. Thermal runaway designates overheating as a result of an exothermic chemical reaction. Because of their size, PEDs can easily be caught between vehicle seats, for example, and as a result damaged mechanically, so that thermal runaway occurs. However, the causes of a thermal runaway can also be general electrical and/or mechanical defects in the battery-operated device or in the battery itself. In addition, overloading of the battery or overheating during operation and/or during charging can cause thermal runaway. The trend of these incidents is rising, according to the Federal Aviation Administration (FAA), see, for example, htpps://www.faa.gov/hazmat/resources/lithium_batteries. The danger resulting from overheating of PEDs is also being investigated intensively, see, for example, https://loki-ped.de/overview. Such overheating and the associated danger that a PED will explode is primarily high in aircraft, where there are only restricted firefighting means available. The IATA recommends, for firefighting, firstly fighting the fire with a fire extinguisher and cooling the heating device with water. An overview of the subject will be found, for example, in https://safetyfirst.airbus.com/lithium-batteries-safe-to-fly/. In principle, there is a wish to provide simple and simultaneously safe handling for burning PEDs which, in particular, represents a safer alternative to the use of Halon fire extinguishers (from 2025, these may no longer be used in the European Union).

From DE 20 2019 103 451 U1, it is known for example to place (burning) PEDs in a fire-resistant pocket. However, toxic smoke that flows out here can easily spread throughout the aircraft cabin. In addition, only a limited period of time can be bridged until an (emergency) landing.

DE 10 2014 209 076 A1 discloses a trolley (aircraft trolley) in which a burning electronic device can be held and which can then be connected to an extinguishing system. Furthermore, a smoke discharge line is optionally provided in this solution, which has an outlet device which is arranged on an outer skin of an aircraft in order to let out the vapors from the fire itself or from the extinguishant used. In particular, the application even proposes a heating device, which is intended to keep the outlet device free of ice. This proposed solution occupies a relatively large amount of space because of the trolley size and is also complex as a result of the attachment of the extraction function to the outer skin, and the de-icing device that is necessary as a result.

### SUMMARY OF THE INVENTION

It is therefore an object of the present invention to provide a solution for fighting battery fires on board an aircraft (in particular in the passenger sector) which is even more efficient and at the same time can easily be handled by the crew.

Accordingly, this object may be achieved with a safety container having the features of one or more embodiments, a aircraft galley having the features of one or more embodiments, and/or an aircraft having the features of one or more embodiments.

The safety container according to the invention for holding at least one burning battery-operated object can be closed in an airtight manner and is fire-resistant and has at least one smoke discharge line. The safety container is preferably cube-shaped and has a front side on which there is an openable flap or door. Smoke from the safety container can be led away in a controlled manner into the at least one smoke discharge line by an overpressure valve on one side of the safety container. The overpressure valve is preferably arranged on the side opposite the openable front side of the safety container, called the “rear side” below. If the pressure exceeds a specific value, the overpressure valve opens mechanically for a specific time period. Of course, this is also possible via an electronic controller which, at a specific pressure, which is detected via a pressure sensor, opens the overpressure valve and closes it again-when the pressure has fallen to a further specific value. It is also conceivable that the safety container also has a temperature sensor in the interior, so that it is possible to display outside the container how hot it (still) is in the interior. Such a display can be made digitally and/or via colored LEDs (e.g. green=normal state; orange =higher than normal state and less than a specific value X° C.; red=higher than a specific value X° C.). Furthermore, cooling devices, which are arranged on the safety container, ensure cooling of the toxic smoke when it leaves the safety container (in the direction of existing discharge lines (“DUCTs”) when installed in an aircraft galley). Such cooling is primarily expedient when the gas heated so highly by the thermal runaway cannot be fed directly into a ventilation system without damaging the latter by the heat. Of course, in principle, an embodiment is also conceivable in which the overpressure valve functions mechanically (therefore has no electronic pressure sensor) and the safety container has a temperature sensor.

These cooling devices according to the invention are close-mesh cooling lines and/or cooling ribs with a high thermal conductivity. The optional cooling ribs intensify the dissipation of heat.

Preferably, the cooling devices are made of copper, since it has a good thermal conductivity (380-400 W/mK).

The safety container according to the invention (including the cooling devices fastened to it) is specifically preferably what is known as an aircraft galley insert (“GAIN”) according to the dimensions of the ARINC Standard 810. This has the advantage that the safety container can be inserted space-efficiently and at a plurality of locations (as desired by the airline) into an existing monument (of the galley) of an aircraft cabin. Of course, a safety container could alternatively in principle also be installed fixedly in the galley, that is to say configured integrally with the aircraft galley monument. However, this has the economic and ecological disadvantage that the effect of a damaged safety container means that the entire aircraft monument has to be replaced. This option is, therefore, expedient only when the safety container is very large in order, for example, to store a whole battery-operated wheelchair. Ultimately, however, it is the airline which will decide over a desired embodiment. Specifically with regard to battery-operated wheelchairs, it is expedient to separate the burning battery from the wheelchair and to accommodate it separately in the safety container according to the invention. Particularly preferably, the safety container has the external dimensions of a GAIN of ARING “size 4”. As a result of the small size and the low weight of the container, a high level of flexibility for the arrangement of a safety container according to the invention in an aircraft galley is provided and barely any space for other galley inserts (e.g. stowage space, oven, coffee machine, etc.) is lost when the safety container is arranged in an aircraft galley.

In a preferred embodiment, the safety container according to the invention further has at least one inductive charging station. Particularly preferably, a base of the safety container forms the inductive charging station. In this way, when no storage is needed for a burning battery-operated device, the safety container is used for efficient and safe utilization of space for, for example, battery-operated crew devices, that is to say so-called “wearable devices” for the flight personnel, which are used for the operative sequence in the cabin during the start, flight and landing, such as a tablet for cabin control functions. The crew devices can accordingly be charged up in the safety container. For this purpose, for example, slip-resistant mats and/or mat inserts with recesses of the size of crew devices can be arranged in the safety container, onto or into which the crew devices can be laid. As compared with cabled charging for the safety container, inductive charging has the advantage that no lead-throughs for the introduction of charging cables are needed, through which—in the event of a fire—smoke could escape.

The aircraft galley according to the invention comprises a safety container as described previously. In this way, the safety container is stowed space-efficiently and securely but at the same time can easily be reached by aircraft crew in the event of a fire.

Optionally, the aircraft galley according to the invention having the safety container proposed here has at least one water line, which is arranged in the physical vicinity of the at least one smoke discharge line in such a way that it is used as an additional cooling device for the smoke after and/or as the latter leaves the safety container.

The aircraft according to the invention, having an aircraft galley as proposed above, has an aircraft ventilation system, wherein the at least one smoke discharge line is coupled to the aircraft ventilation system, so that the toxic smoke can continue to escape safely from the aircraft via the aircraft ventilation system through the so-called outflow valve (installed in the rear (“AFT”) area of the aircraft, i.e. at the end of the aircraft opposite to the direction of flight). In this way, existing pipes are used, and the proposed system comprising a safety container and an aircraft galley which is arranged in an aircraft does not add a large additional weight loading to the overall weight of the aircraft.

The aircraft galley is preferably arranged in the AFT, the rear area of the aircraft. Advantageously, the toxic smoke can be led out of the aircraft from there (as compared with an aircraft galley which is located in the central area of an aircraft) to the outside in the shortest way via the aircraft ventilation system.

It is also conceivable that the aircraft ventilation system of the proposed aircraft having an aircraft galley according to the invention, including the safety container, is a toilet extraction system. Here, there is a separator which separates the solids from the gases: the solids are collected in the aircraft waste tank and the gases are discharged to the outside. Here, extraction of the smoke out of the aircraft is carried out by means of negative pressure.

Preferably, in this variant, the extraction system of a toilet (“lavatory”) in the rear area of the aircraft would be chosen.

### BRIEF DESCRIPTION OF THE DRAWINGS

The invention is explained below with reference to the drawings.

FIG. 1 shows, schematically, the rear side of a safety container according to the invention having cooling elements.

FIG. 2 shows a galley for the AFT area of an aircraft.

FIG. 3 shows an aircraft having an aircraft galley according to the invention in the AFT area, illustrated only schematically.

### DETAILED DESCRIPTION OF THE PREFERRED EMBODIMENTS

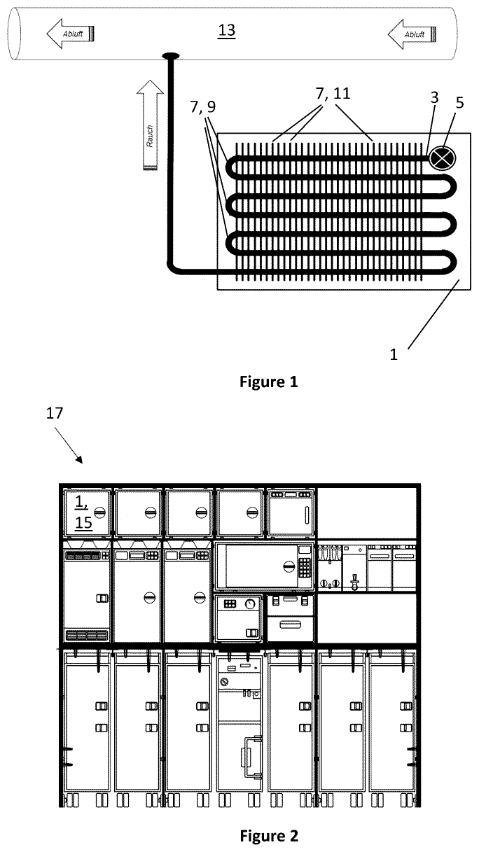

In FIG. 1, the rear side of a safety container 1 according to the invention can be seen. It is used to hold at least one burning battery-operated object, in particular “personal electronic devices” (PEDs) of passengers, such as, for example, mobile telephones, laptops, tablets, smart watches, etc. The safety container 1 can be closed in an airtight manner and is fire-resistant. One possible material for a fire-resistant coating could be, for example, mica or ceramic.

The safety container 1 has a smoke discharge line 3, wherein smoke from the safety container can be led away in a controlled manner into the at least one smoke discharge line 3 through an overpressure valve 5 on one side of the safety container 1. Here, optionally, there can be a temperature and/or pressure sensor (not illustrated) in the safety container 1, which offers the aircraft personnel an indication as to how hot the container or the escaping toxic smoke still is.

Further, cooling devices 7 can be seen in FIG. 1, which are arranged on the safety container 1 to cool the smoke as it leaves the safety container 1. The cooling devices 7 are illustrated as close-mesh spiral smoke discharge lines (also called cooling lines 9 below) and cooling ribs 11, so that, because of the high thermal conductivity of the cooling device material, the hot smoke is cooled down to such an extent that it can be introduced into a ventilation system 13 of an aircraft. The safety container 1 is preferably a so-called galley insert 15, a “GAIN” for short. This is a standardized container for insertion into an aircraft galley 17, as can be seen in FIG. 2. There are GAINs in various orders of size, so that it is possible to store burning electronic devices of different sizes or different numbers. The GAIN 15 in the ARINC size 4 (width 312.4 mm×height 286 mm) is illustrated, which offers the airline the greatest flexibility with regard to the arrangement of the other GAINs. Preferably, the aircraft galley 17 according to the invention is arranged in the rear area of the aircraft, since an outlet valve (“outflow valve”) of the aircraft ventilation system is usually arranged there in the physical vicinity, so that a space-saving and weight-saving installation of an aircraft galley 17 according to the invention having a safety container 1 can be implemented. In this way, smoke from the GAIN 15 can be led away quickly and safely and escape from the aircraft.

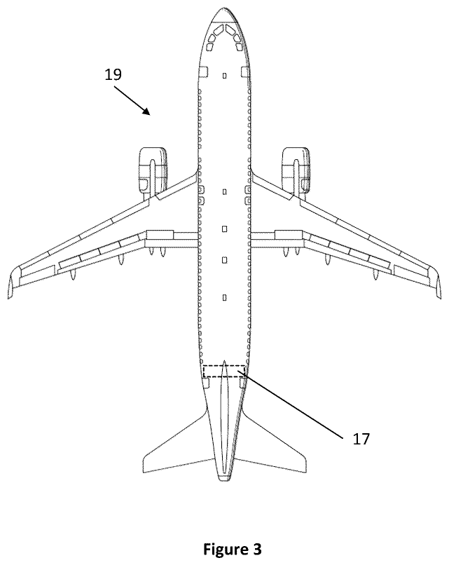

Finally, FIG. 3 shows an aircraft 19 having a schematically shown aircraft galley 17 according to the invention, which is arranged in the rear area of the aircraft (AFT), so that smoke can be fed quickly into existing exhaust air systems and can thus escape from the aircraft 19.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A safety container for holding at least one burning battery-operated object, wherein the safety container is configured to be closed in an airtight manner and is fire-resistant, the safety container comprising:
at least one smoke discharge line, wherein smoke from the safety container is configured to be led away in a controlled manner into the at least one smoke discharge line through an overpressure valve on one side of the safety container; and
one or more cooling devices for cooling the smoke be led away from the safety container arranged on the safety container.

2. The safety container according to claim 1, wherein the one or more cooling devices comprise close-mesh cooling lines, cooling ribs with a high thermal conductivity, or a combination thereof.

3. The safety container according to claim 1, wherein the one or more cooling devices comprise copper.

4. The safety container according to claim 1, wherein the safety container comprises a aircraft galley insert (“GAIN”).

5. The safety container according to claim 1, further comprising:
at least one inductive charging station.

6. An aircraft galley comprising:
the safety container according to claim 1.

7. The aircraft galley according to claim 6, wherein the aircraft galley comprises at least one water line arranged in a physical vicinity of the at least one smoke discharge line in such a way that the at least one water line forms an additional cooling device for smoke after smoke has left the safety container.

8. An aircraft comprising:
the aircraft galley according to claim 6, wherein the at least one smoke discharge line is coupled to an aircraft ventilation system, so that the smoke is configured to leave the aircraft.

9. The aircraft according to claim 8, wherein the aircraft ventilation system is coupled to a toilet extraction system.

10. An aircraft comprising:
the aircraft galley according to claim 6, wherein the aircraft galley is arranged in a rear area of the aircraft.
